(19) United States
(12) Patent Application Publication
(10) Pub. No.: US 2016/0042437 A1
(43) Pub. Date: Feb. 11, 2016

(54) SHOPPING CART APPLICATION

(71) Applicant: 2409959 Ontario Inc., Otterville (CA)

(72) Inventor: Nickolas DeWachter, Ontario (CA)

(21) Appl. No.: 14/455,633

(22) Filed: Aug. 8, 2014

(51) Int. Cl. G06Q 30/06; H04L 29/08

(52) U.S. Cl. CPC G06Q 30/0633; H04L 67/02

(57) ABSTRACT

A mobile device can include a transmitter and a receiver to transmit and receive information, and a memory to store code and/or data. The mobile device can also include a shopping cart app that can store information about the contents of shopping carts associated with various sellers. The shopping cart app can transmit information about the contents of a selected shopping cart to the associated seller, to permit a user to engage in a transaction with the associated seller for the purchase of the items in the shopping cart.

### FIELD OF THE INVENTION

This invention pertains to networked shopping, and more particularly to managing multiple shopping carts on mobile devices.

### BACKGROUND

Today, people have many different ways in which to shop. Aside from brick-and-mortar stores, a significant majority of businesses on the World Wide Web. Customers can visit the Internet sites of the businesses to purchase goods and services offered by the company, and have the goods and services arranged without having to leave the comfort of the house.

The problem with Internet shopping is that it can be difficult to keep track of what a person is looking at from the different shopping websites. Even more than that, it can be difficult to remember what shopping websites a person has visited. Some companies offer many different goods and services, but there generally no shopping websites that offer every good or service that a customer might want. Even shopping websites, such as Amazon.com® and eBay® offer more goods and services than most other websites, but they do not offer every possible good or service. Customers can bounce around from one shopping website to another looking for what they want, and lose track of what shopping websites they had visited. As a result, a customer might forget that there was a particular good or service offered by a particular shopping website, and not go back to the website. As a consequence, the shopping website can end up losing a sale.

Even shopping websites that let customers price-compare the offerings of many different sellers do not solve these problems. For example, travel websites let a customer compare virtually all possible ways to arrange a particular itinerary. But there are so many different such travel websites, not to mention that each airline offers customers the ability to book a trip, that the customer can lose track of exactly which website offered the itinerary the customer wanted.

A need remains for a way to address these and other problems associated with the prior art.

### SUMMARY

In an embodiment of the invention, a mobile device includes a transmitter and a receiver for sending and receiving information. A shopping cart app can store information about shopping carts from different sellers. A user can then use the shopping cart app to select a stored shopping cart and transmit the contents of the shopping cart to the seller. In this manner, the customer and the seller can engage in a transaction.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a mobile device equipped to manage shopping carts from sellers for a customer, according to an embodiment of the invention.

FIG. 2 shows the mobile device of FIG. 1, a seller, and a server connected via networks.

FIG. 3 shows the seller of FIG. 2 transmitting information about a shopping cart to the shopping cart app of FIG. 1.

FIG. 4 shows the shopping cart app of FIG. 1 transmitting information to a seller, so that the seller can engage in a transaction with a customer.

FIGS. 5A-5C show a flowchart of a procedure for using the shopping cart app of FIG. 1 to manage shopping carts from sellers for a customer.

FIG. 6 shows a flowchart of a procedure for the seller of FIG. 3 to transmit information about a shopping cart to the shopping cart app of FIG. 1.

### DETAILED DESCRIPTION

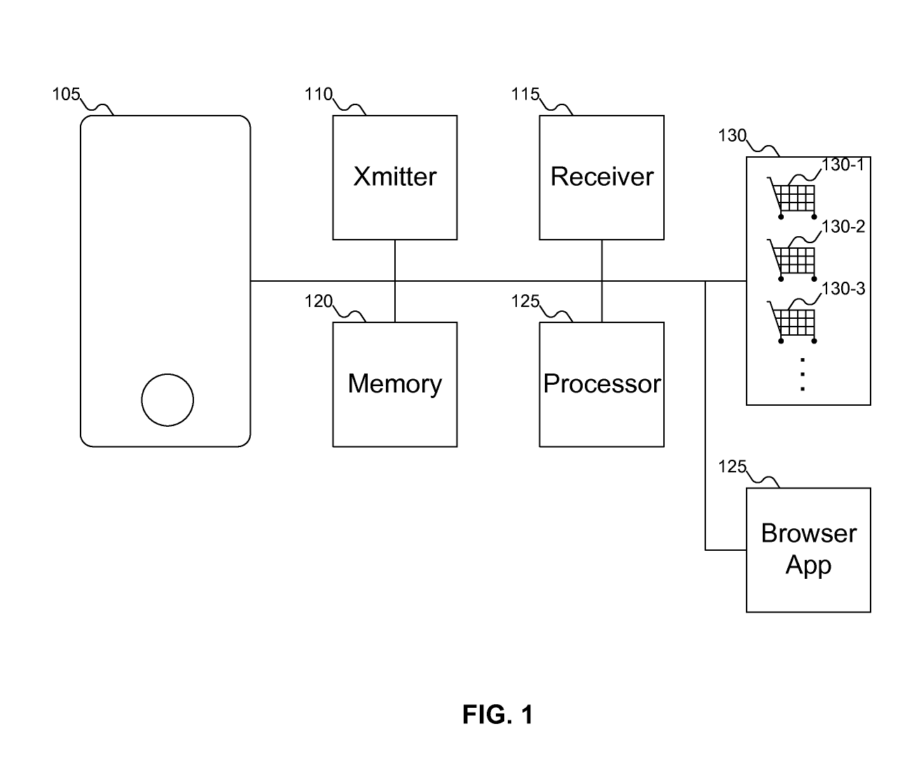

FIG. 1 shows a mobile device equipped to manage shopping carts from sellers for a customer, according to an embodiment of the invention. In FIG. 1, mobile device 105 is shown. Mobile device 105 can be any desired mobile device, including a smart phone, a tablet computer, or a notebook computer. Mobile device 105 includes transmitter 110 and receiver 115, which can be used to transmit information from and receive information at mobile device 105. Mobile device 105 can also include memory 120, which can be used to store code and data, and processor 125, which can be used to execute code.

Mobile device 105 can also include shopping cart app 130. Shopping cart app, as described below, can be used to manage the shopping carts (which can be stored in a list) of various sellers accessible via mobile device 105. In this manner, a user of mobile device 105 can easily manage the shopping carts the user has created, and can easily locate a particular shopping cart containing specific items for purchase. For example, FIG. 1 shows shopping cart app is shown as managing three shopping carts 130-1, 130-2, and 130-3. But a person of ordinary skill in the art will recognize that shopping cart app 130 can manage any number of shopping carts, and that the three shopping carts shown in FIG. 1 is merely exemplary. For purposes of this discussion, the term “app” is considered synonymous with “application”, and both are intended to encompass similar terms, such as “widget”, “add-on”, “add-in”, “extension”, “program”, and so on.

If shopping cart app 130 stores more than one shopping cart, then in all probability the different shopping carts originate from different sellers. Shopping cart app 130 can store information associating the seller from which the shopping cart originated with the shopping cart in its data.

Finally, mobile device 105 can include browser app 125. Browser app 125 is an app that permits the user to access a network, including a global network such as the Internet. Browser app 125 is one way that a user can access a seller. For example, a user can use browser app 125 to visit a website of a seller, select various items for purchase, add those items to the seller's shopping cart, and then purchase those items by checking out from the seller's electronic marketplace. (Throughout this document, although the terms “seller”, “seller's website”, and the like will be variously used, from context the intent should be clear, even if the absolutely correct term is not used. Context should also make clear other related terms, such as “customer” and “user”, for example.)

It goes without saying that the code for executing shopping cart app 130 (and browser app 125), along with the data representing the shopping carts and identifying the associated sellers, can be stored in memory 120.

In contrast to the prior art, when a user adds an item to a seller's shopping cart, the seller's website can then transmit this information to shopping cart app 130 to update shopping cart app 130 about the contents of the customer's shopping cart. In this manner, shopping cart app 130 is kept up-to-date about the contents of shopping carts the customer has created.

While the above description suggests that the seller can update shopping cart app 130 every time the customer adds an item to his shopping cart, other embodiments of the invention are also possible. For example, in other embodiments of the invention the seller can update shopping cart app 130 on a periodic basis (e.g., every minute), on a conditional periodic basis (e.g., every minute, but only if the shopping cart has been updated in the previous minute), or after a specified period of inactivity by the customer (e.g., after the customer has not interacted with the seller's website for 5 minutes), among other possibilities.

Shopping cart app 130 can also update its shopping carts by requesting updated information about the contents of shopping carts 130-1, 130-2, and 130-3 from the associated sellers (that is, the sellers with which shopping carts 130-1, 130-2, and 130-3 were originally generated). For example, when shopping cart app 130 is started or when the user requests an update of shopping carts 130-1, 130-2, and 130-3, shopping cart app 130 can request updated information about the contents of shopping carts 130-1, 130-2, and 130-3 from the associated sellers. Such updated information can include, for example, current pricing of items in the shopping cart, whether items in the shopping cart are currently available, are backordered, or are no longer available, information about related items, and so on.

Shopping cart app 130 can also store shopping carts 130-1, 130-2, and 130-3 in memory 120. By storing shopping carts 130-1, 130-2, and 130-3 in memory 120, the user can review the contents of shopping carts 130-1, 130-2, and 130-3 even without updating shopping carts 130-1, 130-2, and 130-3. This can be useful if mobile device 105 does not have the ability to contact the sellers to get updated information, among other possibilities. For example, if mobile device 105 does not have a functioning connection to the Internet, shopping cart app 130 might not be able to update shopping carts 130-1, 130-2, and 130-3. The user can review shopping carts 130-1, 130-2, and 130-3 based on the most recently stored versions of shopping carts 130-1, 130-2, and 130-3, even while off-line.

Another advantage of embodiments of the invention is that shopping cart app 130 can keep this information even after the seller might have deleted the information. For example, consider the situation where a customer makes selections of items from a seller. The seller's website updates shopping cart app 130 to keep shopping cart app 130 current on the customer's selections. But the customer then leaves the seller, perhaps by closing browser app 125. The seller then deletes the shopping cart from its memory, freeing space for other uses. If the customer were to then restart browser app 125 and return to the seller's website, the customer would not find his shopping cart anymore, and would have to reconstruct the shopping cart manually.

By using shopping cart app 130, the customer can quickly and easily recreate the shopping cart with the seller to complete the purchase. Shopping cart app 130 can transmit information about the customer's shopping cart back to the seller, allowing the seller's website to quickly recreate the shopping cart, even if the seller had deleted the shopping cart from its memory.

While the above description focuses on seller's websites over the Internet, other embodiments of the invention are also possible. For example, instead of being a website accessed via browser app 125, the seller can offer a mobile app that can be installed on mobile device 105. Shopping cart app 130 can interact with the seller's app in the same manner as it interacts with a seller's website via browser app 125.

Shopping cart app 130 can assist the customer in engaging in the transaction with the seller. But shopping cart app 130 itself is not part of the transaction. That is, shopping cart app 130 makes it easier for the customer to recreate and complete the transaction, but shopping cart app 130 does not sell the items to the customer, either directly or indirectly. (Of course, this is not to say that the company that provides shopping cart app 130 does not make any money. But any proceeds from the use of shopping cart app 130 are not a consequence of shopping cart app 130 being considered either buyer or a seller in the transaction between the seller and the customer. Shopping cart app 130 merely helps to facilitate the transaction between the seller and the customer. This is true even if shopping cart app 130 (or more accurately, the company that provides shopping cart app 130) were to receive payment on behalf of the seller from the customer for the items.)

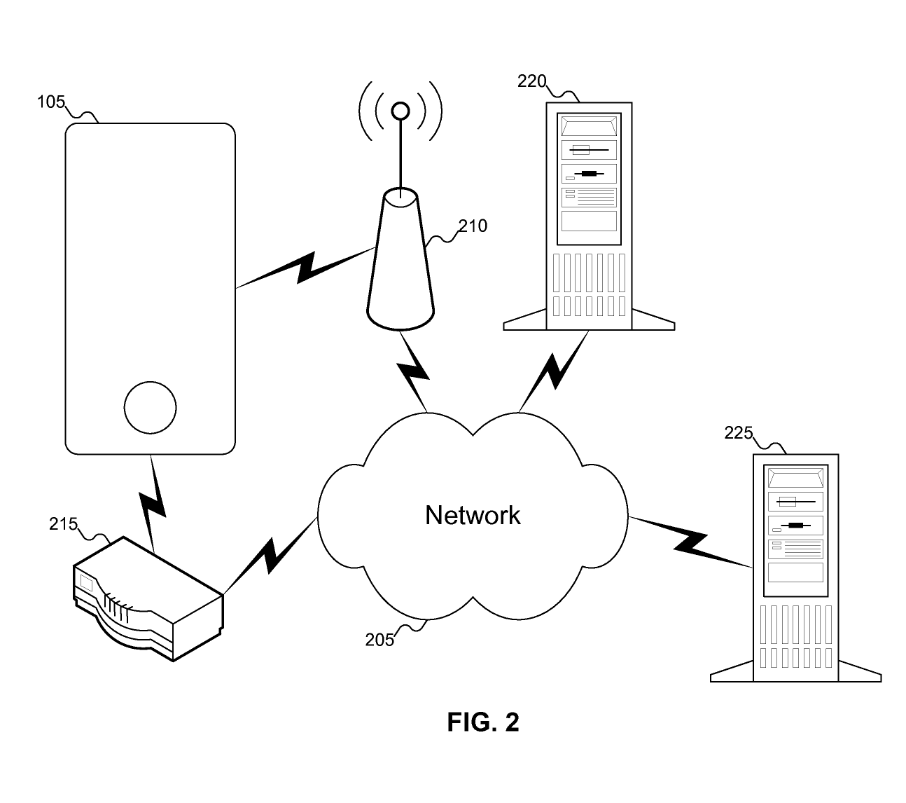

While the above description talks about shopping cart app 130 communicating with the seller, a person of ordinary skill in the art will recognize that normally a seller does not communicate directly with an app on a mobile device. In fact, such communication is achieved indirectly. FIG. 2 shows this situation.

In FIG. 2, mobile device 105 can communicate with network 205, which can be a network like the Internet, via many different possible communication channels. For example, mobile device 105 can communicate with network 205 via cellular link 210, or via a Wi-Fi connection using router 215. (Router 215 is intended to represent all possible variations on Wi-Fi links. Thus, the specific device that mobile device 105 communicates with might be a router, an access point, or a gateway, among other possibilities.) Mobile device 105 can use both connections in serial or in parallel as well, and can also use other possible communication channels.

The seller (via seller's server 220) can communicate shopping cart information. As mentioned above, the seller does not normally communicate directly with mobile device 105. Instead, seller's server 220 transmits information to shopping cart app server 225, which stores the information. Shopping cart app server 225 can then forward the information to the shopping cart app on mobile device 105. This forwarding can be achieved either by shopping cart app server 225 sending the information to the shopping cart app on mobile device 105, or by storing the information until the shopping cart app on the mobile device 105 queries shopping cart app server 225 for any available updates.

With seller's server 220 communicate with shopping cart app server 225, it becomes possible for the shopping cart app to be synchronized across multiple devices. For example, a user might use a tablet to select items from various sellers for inclusion in the seller's shopping carts. The sellers (each potentially from their own seller's server 220) then communicate the shopping cart contents to shopping cart app server 225, from which the shopping cart app can then update itself on the tablet. The user can then switch to another mobile device, such as a smartphone, and activate the shopping cart app on that mobile device. The shopping cart app on the other mobile device can then synchronize with shopping cart app server 225 to update its shopping carts.

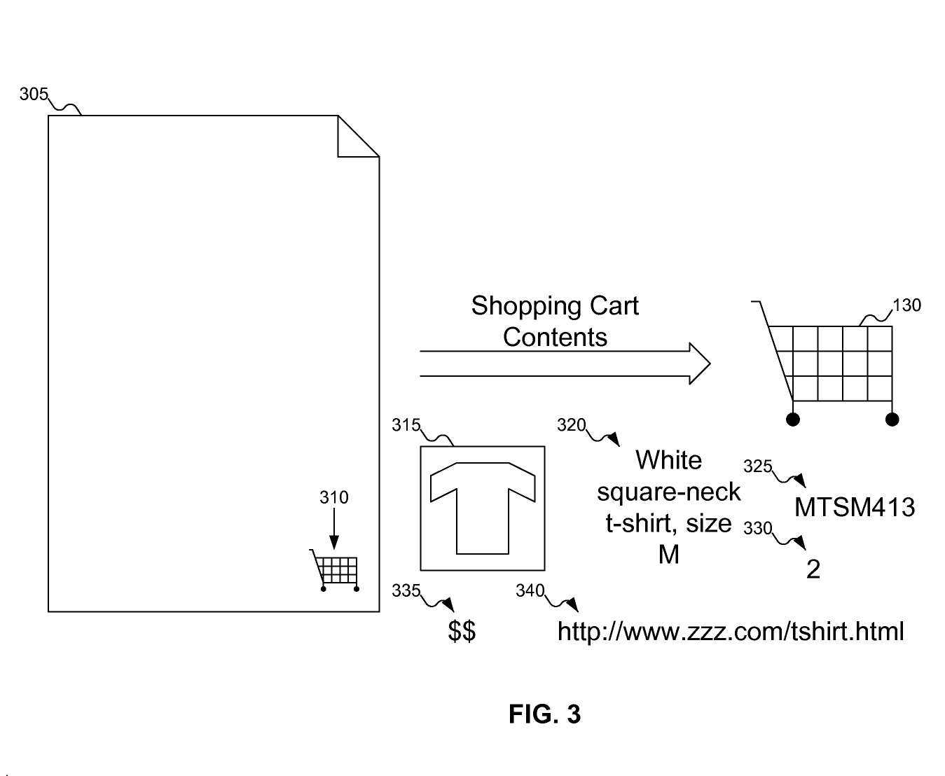

FIG. 3 shows a seller transmitting information about a shopping cart to shopping cart app 130 of FIG. 1. In FIG. 3, seller's website 305 is shown. Seller's website can have its own shopping cart 310, into which a customer has selected various items. Seller's website is shown transmitting the contents of the customer's shopping cart at the seller's website to shopping cart app 130. Examples of the type of information about the shopping cart the seller's website can transmit include image 315 showing the item, name 320 describing the item, item descriptor 325 that uniquely identifies the item within the seller's inventory, quantity 330 indicating how many copies of the item the customer has selected, and price 335 specifying how much the item costs. Other types of information can also be included in the contents of the shopping cart: for example, any specifications for the item, any reviews/comments about the item, or any questions/answers related to the item. Still other types of information that can be included in the contents of the shopping cart are related items (for example, other items often bought at the same time as the selected item, particularly if such related items are not currently in the customer's shopping cart). The user can then view information about the contents of the customer's shopping cart with seller 305 within shopping cart app 130. For example, upon selecting the shopping cart associated with seller 305, shopping cart app 130 can display to the customer the contents of the selected shopping cart.

Seller 305 can also transmit hyperlink 340 to shopping cart app 130. Hyperlink 340 is a link to information about the item. If user selects hyperlink 340, shopping cart app 130 can use hyperlink 340 to provide the user with additional information about the item. In one embodiment, shopping cart app 130 can open up the browser app on the mobile device (shown on FIG. 1) to access the information from hyperlink 340 for display to the user. In another embodiment, shopping cart app 130 can have its own browser functionality (for example, a browser window within shopping cart app 130), and can display the information locally.

As discussed above, seller 305 does not have to transmit information directly to shopping cart app 130. Instead, seller 305 can transmit information to the shopping cart app server (as shown in FIG. 2), which can then relay the information to shopping cart app 130 (for example, when shopping cart app 130 requested updated information about the contents of the shopping carts in shopping cart app 130).

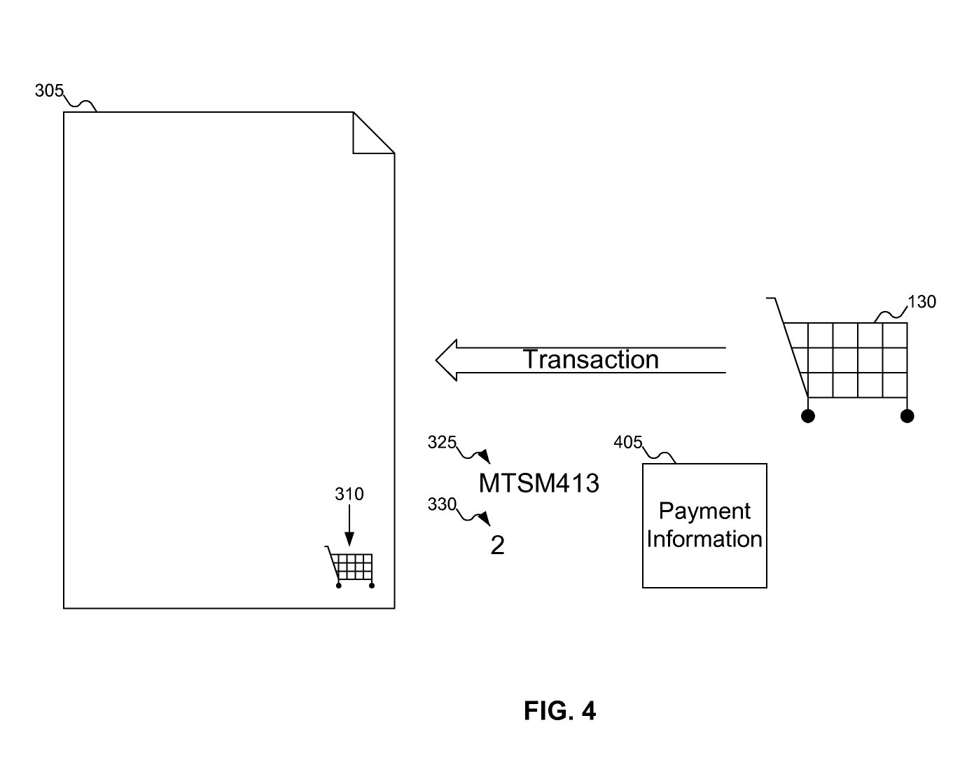

A customer can also select a shopping cart from shopping cart app 130 and choose to complete the transaction represented by that shopping cart. Shopping cart app 130 can transmit to seller 305 information seller 305 needs to complete the transaction. This can include the item descriptor 325 and quantity 330. FIG. 4 shows the shopping cart app of FIG. 1 transmitting information to a seller, so that the seller can engage in a transaction with a customer. Shopping cart app 130 can also optionally send payment information 405 to seller 305. Payment information can be information that the customer has stored with shopping cart app 130: for example, information about one of the customer's credits cards. This can expedite completing the transaction, since the customer would not need to manually enter the payment information.

In comparing FIGS. 3 and 4, it should be apparent that seller 305 typically transmits more information to shopping cart app 130 than shopping cart app 130 transmits to seller 305. This is because seller 305 can always access information about its own product from its own storage. Seller 305 just needs enough information to know what products the customer has selected, how many of each product, and (optionally) payment information for the transaction.

As discussed above, seller 305 and shopping cart app 130 do not have to directly communicate. In FIG. 4, shopping cart app 130 can transmit information to the shopping cart app server (as shown in FIG. 2), which can then relay information to seller 305.

While FIGS. 3 and 4 show information about a single product being transmitted, a person skilled in the art will recognize that a shopping cart can include many items. As such, transmissions between seller 305 and shopping cart app 130 can include information for all items in the shopping cart, however many items there are.

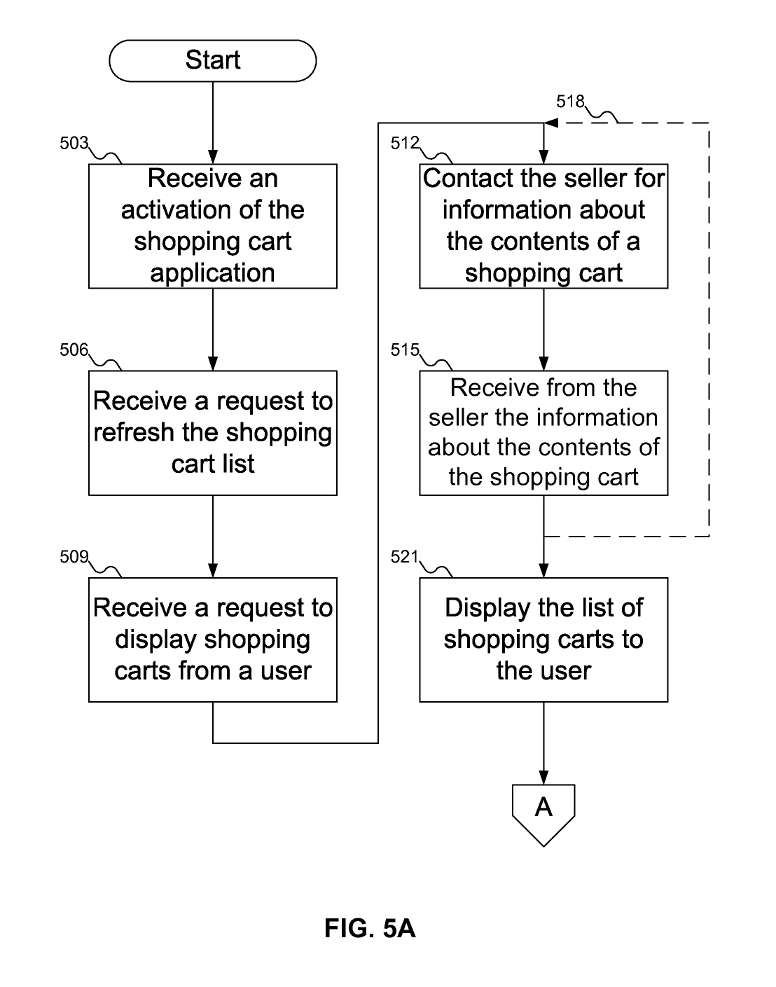

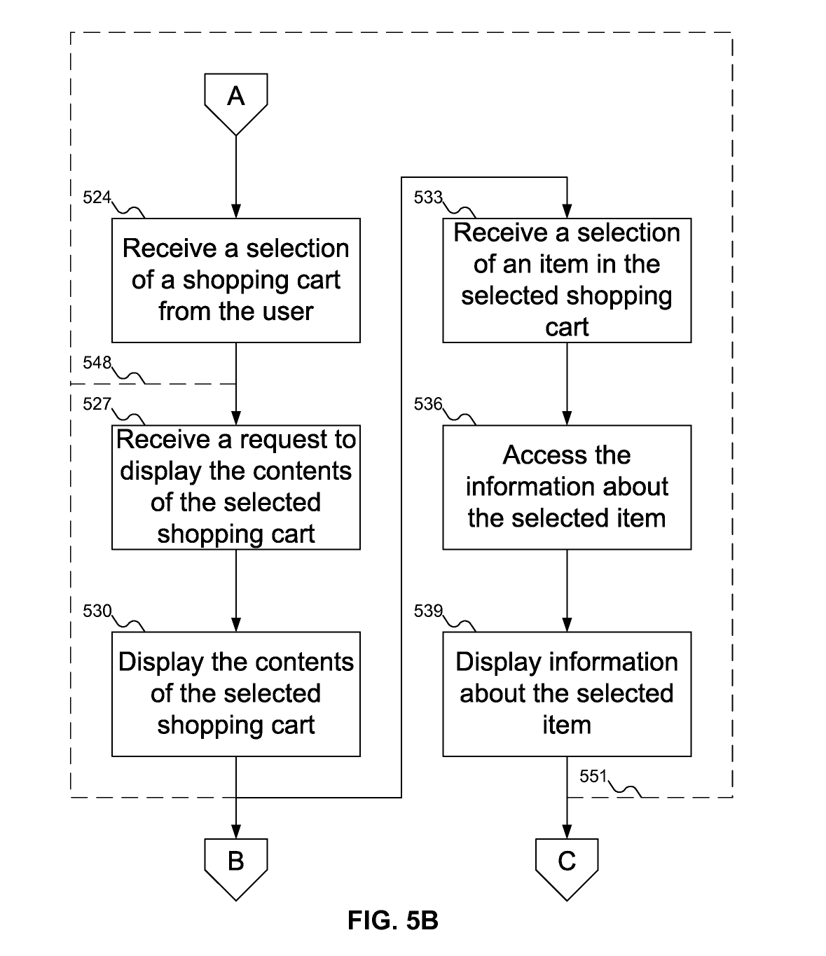

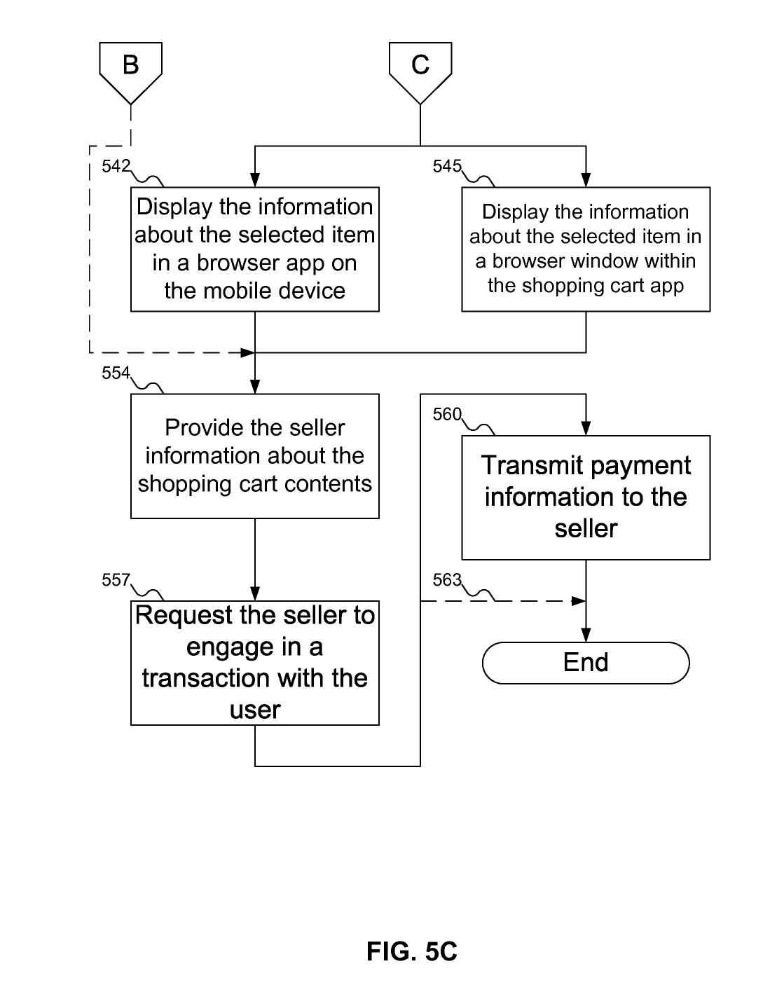

FIGS. 5A-5C show a flowchart of a procedure for using the shopping cart app of FIG. 1 to manage shopping carts from sellers for a customer. In FIG. 5A, at block 503, the mobile device can receive an activation of the shopping cart app. At block 506, the shopping cart app can receive a request to update the list of shopping carts managed by the shopping cart app. At block 509, the shopping cart app can receive a request to display shopping carts managed by the shopping cart app. At block 512, the shopping cart app can contact the seller for information about the contents of the shopping cart. At block 515, the shopping cart app can receive from the seller the information about the contents of the shopping cart. As shown by dashed line 518, blocks 512 and 515 can be repeated multiple times as appropriate to the contents of the shopping cart, and/or for multiple shopping carts. At block 521, the shopping cart app can display the list of shopping carts to the user.

While blocks 512 and 515 describe the shopping cart app and the seller as communicating directly, direct communication is not required. The seller and the shopping cart app can communicate through the shopping cart app server, as described above in FIGS. 2-4 and the accompanying description.

At block 524 (FIG. 5B), the shopping cart app can receive from the user a selected shopping cart. At block 527, the shopping cart app can receive a request to display the contents of the selected shopping cart app. At block 530, the shopping cart app can display the contents of the selected shopping cart. At block 533, the shopping cart app can receive a selection of an item in the selected shopping cart. At block 536, the shopping cart app can access information about the selected item. At block 539, the shopping cart app can display information about the selected item.

Various blocks can be omitted without affecting the functionality the shopping cart app. For example, blocks 527 through 539 (along with blocks 542 and 545 of FIG. 5C) can be omitted without affecting functionality of the shopping cart app, as shown by dashed arrow 548. Similarly, blocks 542 and 545 of FIG. 5C can be omitted, as shown by dashed arrow 551.

Continuing with FIG. 5C, at block 542, the shopping cart app can display the information about the selected item in a browser app on the mobile device. Alternatively, at block 545, the shopping cart app can display the information about the selected item in a browser window within the shopping cart app.

Regardless of whether or how the information about the selected item is displayed, at block 554 the shopping cart app can provide the seller with information about the contents of the selected shopping cart. At block 557, the shopping cart app can request that the seller engage in a transaction with the customer for the purchase of the selected items. At block 560, the shopping cart app can provide the seller with payment information. As shown by dashed line 563, block 560 can be omitted.

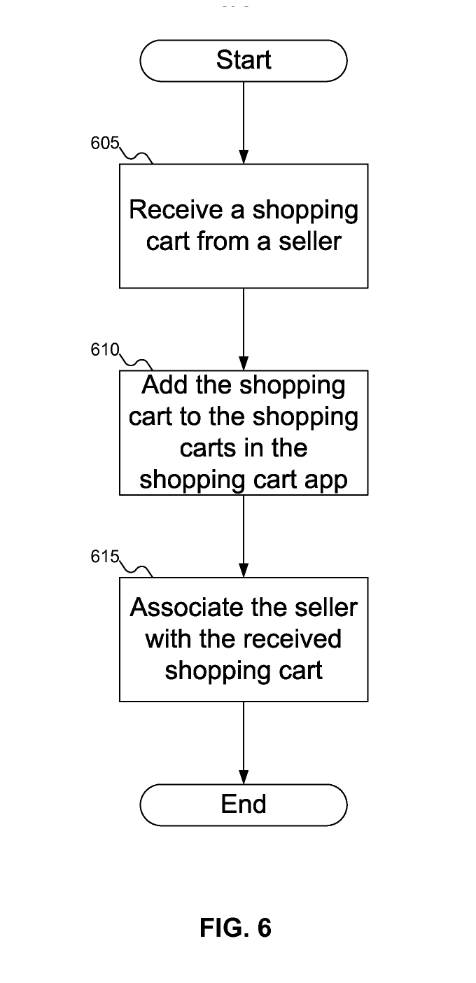

FIG. 6 shows a flowchart of a procedure for the seller of FIG. 3 to transmit information about a shopping cart to the shopping cart app of FIG. 1. In FIG. 6, at block 605, the shopping cart app receives a shopping cart from the seller. At block 610, the shopping cart app adds the received shopping cart to the shopping carts managed by the shopping cart app. At block 615, the shopping cart app associates the seller with the shopping cart, so that if the customer selects the shopping cart to complete the proposed transaction, the shopping cart app can identify the seller.

The embodiments of the invention represented in the above flowcharts are merely exemplary, and are not intended to represent the only operative embodiment of the invention. Various blocks can be omitted, and the sequence of blocks can reordered, without affecting the employability of the embodiments of the invention. While the drawings might show specific ways in which blocks can be omitted or arranged, other arrangements are also possible and are intended to be covered by embodiments of the invention.

The following discussion is intended to provide a brief, general description of a suitable machine in which certain aspects of the invention can be implemented. Typically, the machine includes a system bus to which is attached processors, memory, e.g., random access memory (RAM), read-only memory (ROM), or other state preserving medium, storage devices, a video interface, and input/output interface ports. The machine can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine can include embedded controllers, such as programmable or non-programmable logic devices or arrays, Application Specific Integrated Circuits, embedded computers, smart cards, and the like. The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

The invention can be described by reference to or in conjunction with associated data including functions, procedures, data structures, application programs, instructions, etc. which, when accessed by a machine, result in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, and other tangible, physical storage media. Associated data can also be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as can come within the scope and spirit of the following claims and equivalents thereto.

1. A mobile device, comprising:
a transmitter to transmit a first information;
a receiver to receive a second information;
a memory; and
a shopping cart app, the shopping cart app capable of storing in the memory information about a contents of at least one shopping cart from an associated seller and capable of transmitting information about the contents of the at least one shopping cart to the associated seller as the first information, so that the associated seller can engage in a transaction with a user to sell the contents of the at least one shopping cart to the user,
wherein the shopping cart app does not sell the contents of the selected shopping cart to the user, either directly or indirectly.

2. A mobile device according to claim 1, wherein the transmitter and receiver are capable of communicating with a global network.

3. A mobile device according to claim 2, wherein the transmitter and receiver operate over a cellular link.

4. A mobile device according to claim 2, wherein the transmitter and receiver operate over Wi-Fi.

5. A mobile device according to claim 1, wherein the shopping cart app is capable of receiving the contents of the at least one shopping cart from the associated seller as the second information.

6. A mobile device according to claim 1, wherein the contents of the at least one shopping cart include an item descriptor of an item, a name for the item, a price for the item, and a quantity for the item.

7. A mobile device according to claim 6, wherein the contents of the at least one shopping cart further include a hyperlink for the item.

8. A mobile device according to claim 7, wherein the shopping cart app is capable of using hyperlink for the item to display current information from the associated seller about the item.

9. A mobile device according to claim 8, wherein the shopping cart app includes a browser window to display the current information from the associated seller about the item.

10. A mobile device according to claim 8, wherein:
the mobile device further comprises a browser app; and
the shopping cart app is capable of activating the browser app using the hyperlink to display the current information from the associated seller about the item.

11. A mobile device according to claim 1, wherein the associated seller can recreate shopping cart from the first information.

12. A mobile device according to claim 1, wherein the first information includes payment information of the user.

13. A mobile device according to claim 1, wherein the shopping cart app can receive from the associated seller the at least one shopping cart as the second information.

14. A mobile device according to claim 13, wherein the second information includes at least one item in the at least one shopping cart, an item descriptor for the at least one item in the at least one shopping cart, a price for the at least one item in the at least one shopping cart, a quantity for the at least one item in the at least one shopping cart, and a hyperlink for the item.

15. A method, comprising:
receiving, from a user on a mobile device, a request to display a list of shopping carts within a shopping cart app;
displaying the list of shopping carts;
receiving, from the user, a selection of a selected shopping cart from the list of shopping carts, the selected shopping cart having an associated seller; and
providing the associated seller with information about a contents of the selected shopping cart, so that the associated seller can engage in a transaction with the user to sell the contents of the selected shopping cart to the user,
wherein the shopping cart app does not sell the contents of the selected shopping cart to the user, either directly or indirectly.

16. A method according to claim 15, wherein receiving a request to display a list of shopping carts within a shopping cart app includes activating the shopping cart app on the mobile device by the user.

17. A method according to claim 15, wherein receiving a request to display a list of shopping carts within a shopping cart app includes receiving from the user a request to refresh the list of shopping carts.

18. A method according to claim 15, wherein displaying the list of shopping carts includes:
for each shopping cart in the list of shopping carts, contacting an associated seller for updated information about a content of the shopping cart; and
for each shopping cart in the list of shopping carts, receiving from the associated seller the updated information about the content of the shopping cart.

19. A method according to claim 15, further comprising:
receiving from the user a request to review the contents of the selected shopping cart; and
displaying the contents of the selected shopping cart.

20. A method according to claim 19, further comprising:
receiving from the user a selection of an item in the selected shopping cart; and
displaying information about the selected item in the selected shopping cart.

21. A method according to claim 20, wherein displaying information about the selected item includes:
accessing the information about the selected item from a hyperlink associated with the selected item; and
displaying the information about the selected item in a browser window within the shopping cart app on the mobile device.

22. A method according to claim 20, wherein displaying information about the selected item includes:
accessing the information about the selected item from a hyperlink associated with the selected item; and
displaying the information about the selected item in a browser app on the mobile device.

23. A method according to claim 15, wherein providing the associated seller with information about a contents of the selected shopping cart includes requesting the associated seller to engage in a transaction with the user for the contents of the shopping cart.

24. A method according to claim 23, wherein providing the associated seller with information about a contents of the selected shopping cart further includes transmitting the contents of the selected shopping cart to the associated seller, so that the selected shopping cart can be recreated by the associated seller.

25. A method according to claim 23, wherein providing the associated seller with information about a contents of the selected shopping cart further includes transmitting to the associated seller payment information of the user.

26. A method according to claim 15, further comprising:
receiving from the associated seller the contents of the selected shopping cart;
adding the received selected shopping cart to the list of shopping carts; and
associating the associated seller with the selected shopping cart.

27. A method according to claim 26, wherein receiving from the associated seller the contents of the selected shopping cart includes receiving from the associated seller at least one item in the selected shopping cart, an item descriptor for the at least one item in the selected shopping cart, a price for the at least one item in the selected shopping cart, and a quantity for the at least one item in the at least one shopping cart.

28. A tangible computer-readable medium storing non-transitory computer-executable instructions that, when executed by a processor, operate to perform the method according to claim 15.
